(19) United States
(12) Patent Application Publication
(10) Pub. No.: US 2020/0226649 A1
(43) Pub. Date: Jul. 16, 2020

(54) GATELESS PARKING ACCESS REVENUE CONTROL SYSTEM

(71) Applicant: FlashParking, Inc., Austin, TX (US)

(72) Inventors: Juan Fabian Rodriguez, Austin, TX (US); Dean Alan Cleaver, Austin, TX (US); Eliseo Joaquin Diaz, Austin, TX (US); Carlos Hernandez, Austin, TX (US)

(73) Assignee: FlashParking, Inc., Austin, TX (US)

(21) Appl. No.: 16/739,962

(22) Filed: Jan. 10, 2020

Related U.S. Application Data
(60) Provisional application No. 62/790,801, filed on Jan. 10, 2019.

(51) Int. Cl. G06Q 30/02; G06Q 50/30

(52) U.S. Cl. CPC G06Q 30/0284; G06Q 50/30

(57) ABSTRACT

A gateless parking management system is disclosed. When a vehicle entering a parking facility is proximal to a beacon, the beacon pushes payment information to the driver's mobile device or the vehicle's head unit and a license plate recognition camera captures and transmits license plate information to a back-end system through the cloud. After entering the parking facility, the driver has a limited amount of time to make payment, either through the mobile application or at pay-by-plate pay stations positioned proximal to parking spaces in the parking facility. If the driver fails or refuses to make payment within the allotted time, the system may initiate an enforcement action.

### PRIORITY STATEMENT UNDER 35 U.S.C. § 119 & 37 C.F.R. § 1.78

This non-provisional application claims priority based upon prior U.S. Provisional Patent Application Ser. No. 62/790,801 filed Jan. 10, 2019 in the names of Juan Fabian Rodriguez, Dean Alan Cleaver, Eliseo Joaquin Diaz, and Carlos Hernandez entitled “GATELESS PARKING ACCESS REVENUE CONTROL SYSTEM,” the disclosures of which are incorporated herein in their entirety by reference as if fully set forth herein.

### BACKGROUND OF THE INVENTION

Currently, parking operators or parking asset owners do not have a way to allow parking customers to enter and exit parking facilities (parking garages or surface lots) seamlessly and gatelessly while maintaining an accurate level of revenue control, occupancy counts and intelligent monitoring to know when enforcement is required. Today, parking operators have two main alternatives for controlling revenue in parking facilities: gated parking access revenue control systems and pay-by-space revenue control systems.

A gated parking access revenue control system requires every entry and exit lane to the parking facility to have a parking gate operator. Those gates are connected to a ticket dispenser and/or device to verify parking. This system does not require enforcement because the parking gate operators will ensure parkers stop and pay their parking fees. However, this process significantly impedes entry and exit of the parking facility.

The pay-by-space revenue control systems include (i) a pay and display, (ii) pay-by-space, or (iii) pay-by-plate multi-space meter. This type of system facilitates entry and exit from the parking facility because it does not require the parking facility to have a parking gate operator. However, this approach causes a significant revenue loss, because parking customers do not always pay, and it is not cost effective to have an enforcement officer 365 days 24/7 in the parking facility.

Therefore, there is a need for a method and system that allows parking operators to be able to have high level of revenue control while allowing parking customers to enter and exit the parking facility without having to stop at a parking gate, while knowing when to send an enforcement officer.

### SUMMARY OF THE INVENTION

Various embodiments of the present invention allow customers to enter and exit parking facilities seamlessly and without having, for example, to stop at a parking gate to obtain a parking access control system and a pay-by plate or pay-by-space multi-space meter.

When entering a parking facility, a beacon senses the vehicle's location and broadcasts information regarding the parking fee to an application on the driver's mobile device or the vehicle's head unit. A license plate recognition camera captures license plate information and transmits it to the system's back-end system through the cloud. Pay-by-license-plate parking meters or pay stations are located proximally to the parking spaces in the parking facility.

After entering the parking facility, the driver has a limited time to make payment, either through the application on the driver's mobile device or by physically making payment at a pay station. In some embodiments, if the parking customer is using a mobile application, the Eddystone or other beacon will initiate the payment process via a push notification upon entry to the parking facility. If payment is not made within the allotted time, the back-end system initiates enforcement action, such as sending a notification to an enforcement officer to take appropriate action.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 depicts a schematic diagram of one embodiment of the gateless parking management system of the present invention.

### DESCRIPTION OF THE PREFERRED EMBODIMENTS

Embodiments of the present invention relate generally to yield management in parking facilities. More specifically, those embodiments relate to a gateless parking access control system. The configuration and use of the presently preferred embodiments are discussed in detail below. It should be appreciated, however, that the present invention provides many applicable inventive concepts that can be embodied in a wide variety of contexts other than parking facility management. Accordingly, the specific embodiments discussed are merely illustrative of specific ways to make and use the invention, and do not limit the scope of the invention. In addition, the following terms shall have the associated meaning when used herein:

“application” is a software program designed to run on a mobile device;

“cloud” means a collection of logical devices which may or may not include underlying physical servers, wherein all such logical devices may be accessed without any knowledge, or with limited knowledge, of the underlying physical devices, and wherein the collection of logical devices has persistent logical resources, but is non-deterministic in its use of physical resources;

“Eddystone beacon” means Google's Bluetooth low energy proximity sensing device;

“head unit” means a hardware and software interface integrated into a vehicle such as a car or truck that gives the user control over the vehicle's information and entertainment media, such as AM/FM radio, satellite radio, dash cams, GPS navigation, Bluetooth, wifi and the like;

“iBeacon” means Apple Computer's Bluetooth low energy proximity sensing device;

“mobile device” means any portable computing device, typically having a display screen with touch input and/or a miniature keyboard, and includes, without limitation, the head unit;

“parking facility” means an indoor or outdoor area for parking vehicles, including, for example, a parking garage, parking lot, parking ramp, car park and the like; and

“sensing device” means an iBeacon, an Eddystone beacon, or any other similar Bluetooth low energy device that broadcasts its identifier to nearby mobile devices.

When implemented, various embodiments of the present invention include one or more Eddystones or other beacons and one or more license plate recognition cameras positioned at the entry and exit lanes of the parking facility. The beacon senses the proximity of a vehicle entering the parking facility and the cameras capture the license plate number of the vehicle. The parking facility is configured with parking meters or pay stations positioned at each parking space, or multi-space positioned proximal to more than one parking space. In some embodiments, the parking meters include mobile payment options, such as through a mobile application, such as iOS or Android, through the vehicle's head unit, or through text or interactive voice response (IVR).

When a customer arrives at the parking facility, they pass through an entry lane and the license plate camera captures license plate information, such as the vehicles license plate number, and transmits it to a cloud-based back-end system. Thereafter, the parking customer will have a limited amount of time to make payment such as, for example, physically proceeding to the parking meter and make pay-by-plate payment or making payment through a mobile application, such as iOS or Android, through the vehicle's head unit, or through text or interactive voice response (IVR). In some embodiments, if the parking customer is using a mobile application, the Eddystone or other beacon will initiate the payment process via a push notification upon entry to the parking facility.

If the customer fails or refuses to make payment within the allotted time, the system may initiate an enforcement action, such as notifying an enforcement officer to review the situation and, as applicable, ticket the vehicle, tow the vehicle, or put an immobilizing device, such as parking boot, on the vehicle. In some embodiments, it may be desirable to deploy a robotic license plate recognition rover to maximize the enforcement officer's time. The robotic rover communicates with the back-end system and moves within the parking facility to monitor, through license plate recognition, the location of vehicles in the parking facility. By reporting this information to the back-end system, the precise location of the vehicle is known when enforcement action is required.

As will be appreciated by those skilled in the art, embodiments of the present invention greatly improve the parking experience for both transient daily parkers and monthly parkers who frequent a parking facility. Parking customers may, for example, include monthly contract parkers, pre-paid parking customers, and parking customers using an online parking reservation platform, such as SpotHero, Parkwhiz, TicketMaster and others. The system may be configured to handle all different types of parking customers; the rules will vary based on the customer type.

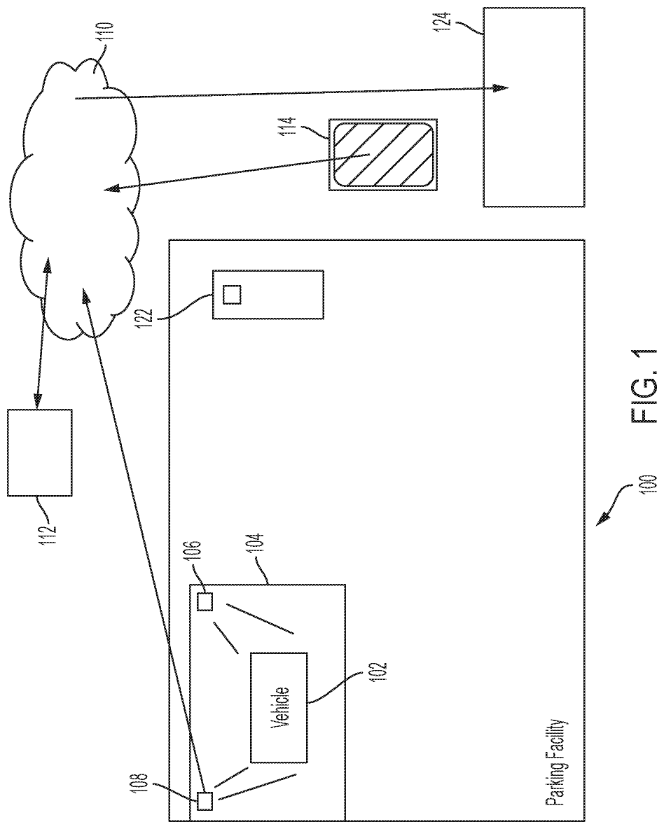

Referring now to FIG. 1 which depicts a parking facility 100 configured with one embodiment of the present invention. A vehicle 102 enters a parking facility's entry lane 104. A license plate reader 108 reads and records the vehicle's license plate. Alternatively, the license plate reader 108 reads the license plate and transmits the information through the cloud 110 to the back end system 112. A beacon 106 broadcast the location of the vehicle to a mobile application on the user's mobile device 114 or the head unit of the vehicle 102. The user could be the driver, a passenger or other individual responsible for parking payment.

The driver, a passenger or another party could approach a pay-by-license-plate kiosk 122 to make payment. Alternatively, the driver, a passenger or another party could make payment using an application, such as iOS or Android, on that party's mobile device 114, such as through a text message or IVR. In still other embodiments, payment may be made through the vehicle's head unit.

In some embodiments, the driver will have a limited amount of time to make the payment. The required timing and the confirmation that payment has been received within the allotted time are managed through the back-end system 112. If payment is not made within the allotted time, the back-end system 112 may initiate an enforcement action, such as notifying an enforcement division 124 to review the situation and, as applicable, ticket the vehicle 102, tow the vehicle 102, or put an immobilizing device, such as parking boot, on the vehicle 102. Alternatively, the back-end system may be programmed to alert the driver of the vehicle 102 by SMS, email, data push or through an enforcement mobile application.

Various embodiments of the present invention include a parking facility management system, which includes an entry lane providing vehicular access to a parking facility, a license plate reader positioned proximal to the entry lane, a beacon positioned proximal to the entry lane, a pay station located within the parking facility; and a back-end system communicatively connected through the cloud to the license plate reader, the beacon and the pay station, the back-end system configured to receive license plate information from the license plate reader, instruct the beacon to push payment information to a mobile device when a vehicle is proximal to the beacon, transmit and receive payment information from the pay station and, if payment is not received within a predetermined time, instruct enforcement action to be initiated.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for parking management known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A parking facility management system, comprising:
an entry lane providing vehicular access to a parking facility;
a license plate reader positioned proximal to the entry lane;
a beacon positioned proximal to the entry lane;
a pay station located within the parking facility; and
a back-end system communicatively connected through the cloud to the license plate reader, the beacon and the pay station, the back-end system configured to receive license plate information from the license plate reader, instruct the beacon to push payment information to a mobile device when a vehicle is proximal to the beacon, transmit and receive payment information from the pay station and, if payment is not received within a predetermined time, instruct enforcement action to be initiated.

2. The parking facility management system of claim 1, wherein the parking facility is a parking garage.

3. The parking facility management system of claim 1, wherein the pay station is a pay-by-plate payment kiosk.

4. The parking facility management system of claim 1, wherein payment information received from the pay station includes time, date and amount of payment.

5. The parking facility management system of claim 1, further including a robotic rover in communication with the back-end system, wherein the robotic rover travels within the parking facility identifying the location of vehicles having license plates with information corresponding to the license plate information received by the back-end system from the license plate reader.

6. A parking facility management system, comprising:
an entry lane providing vehicular access to a parking facility;
a license plate reader positioned proximal to the entry lane;
a beacon positioned proximal to the entry lane;
a pay station located within the parking facility; and
a back-end system communicatively connected through the cloud to the license plate reader, the beacon and the pay station,
wherein, as a vehicle enters the entry lane, the license plate reader transmits license plate information to the back-end system through the cloud, the back-end system instructs the beacon to broadcast payment-related information to a mobile device, the back-end system transmits payment information to the pay station and, if payment is not made through either the mobile device or the pay station with in a pre-designated time, the back-end system initiates enforcement action.

7. The parking facility management system of claim 6, wherein the parking facility is a parking garage.

8. The parking facility management system of claim 6, wherein the pay station is a pay-by-plate payment kiosk.

9. The parking facility management system of claim 6, wherein payment information received from the pay station includes time, date and amount of payment.

10. The parking facility management system of claim 6, further including a robotic rover in communication with the back-end system, wherein the robotic rover travels within the parking facility identifying the location of vehicles having license plates with information corresponding to the license plate information received by the back-end system from the license plate reader.
